(19) United States
(12) Patent Application Publication
(10) Pub. No.: US 2014/0201688 A1
(43) Pub. Date: Jul. 17, 2014

(54) USER INTERFACE - GESTURAL TOUCH

(71) Applicant: BSH HOME APPLIANCES CORPORATION, Irvine, CA (US)

(72) Inventors: Raphael Guilleminot, San Francisco, CA (US); Phillip Montanye, New Bern, NC (US); Graham Sadtler, Huntington Beach, CA (US); Robert Tannen, Philadelphia, PA (US)

(73) Assignee: BSH HOME APPLIANCES CORPORATION, Irvine, CA (US)

(21) Appl. No.: 13/743,483

(22) Filed: Jan. 17, 2013

(51) Int. Cl. G06F 3/01

(52) U.S. Cl. CPC G06F 3/017
USPC 715/863

(57) ABSTRACT

A method for controlling a domestic appliance that treats contents, said domestic appliance having a display, a controller, and at least one user input component, the method comprising: displaying a first screen on the display; detecting user input to the at least one user input component; correlating the user input to a gesture type with the controller; determining the gesture type from among a plurality of gesture types with the controller; and displaying a second screen on the display according to at least the gesture type, wherein said second screen is different from said first screen.

### FIELD OF THE TECHNOLOGY

The present technology relates to a user interface for a domestic appliance, e.g., an oven. More particularly, the present technology relates to gestural inputs to the user interface.

### BACKGROUND OF THE TECHNOLOGY

Commonly, modern domestic appliances include some form of user interface by which to input operational parameters by which the user would like the appliance to operate. The user interface will comprise some type of display such as an alphanumeric display similar to the display taught by Lapeyre et al., U.S. Pat. No. 3,872,463 or Hedin, U.S. Pat. No. 4,109,245. Alternatively, the appliance may include a more advanced display capable of showing complex images, such as an LCD display having a large number of pixels, similar to a common flat screen television.

The user interface will also include one or more user input components. These user input components may be one or a combination of mechanical knobs, buttons, switches that receive the user's input. There may also be touch input elements such as resistive or capacitive touch elements that receive the user's input. The touch elements may also be incorporated into the display to create a touch screen system.

The operation of the display and user input component, along with the operation of the domestic appliance is coordinated by a controller. The controller is programmed with inputs received by the user input component. The controller also instructs the display to display various screens or parameters in accordance with user inputs and/or the status of the appliance.

In the case of an appliance with a more complex user interface which displays a variety of screens, there may be certain screens that the user desires to reach expeditiously or the user may seek to bring up a particular screen by a more intuitive input. Simple button presses may not be practical because a particular screen may be displaying a large quantity of information such that the addition of further buttons would crowd the screen and confuse the user.

Thus, presently known domestic appliance user interfaces may present a difficulty to the user in that the user may not be able to reach certain screens simply and quickly.

### SUMMARY OF THE TECHNOLOGY

One aspect of the present technology is to provide a method for controlling a user interface of a domestic appliance that overcomes one or more shortcomings of the prior art.

Another aspect of the present technology is directed to a method for controlling a domestic appliance that treats contents, said domestic appliance having a display, a controller, and at least one user input component. The method comprises displaying a first screen on the display, detecting user input to the at least one user input component; correlating the user input to a gesture type with the controller, determining the gesture type from among a plurality of gesture types with the controller, and displaying a second screen on the display according to at least the gesture type, wherein said second screen is different from said first screen.

In examples, (a) the method may include determining whether at least one treatment parameter has been programmed to the controller, wherein the gesture type comprises an upward swipe or a downward swipe, wherein the second screen comprises one of a treatment mode info screen, a timer info screen, and a set timer screen, and wherein the at least one treatment parameter comprises at least one of a treatment mode, a timer selection, and a treatment time, (b) when the timer selection and the treatment time have been programmed to the controller and the gesture type is the downward swipe, the second screen may be the timer info screen that displays the timer selection and the treatment time, (c) when the timer selection and the treatment time have not been programmed to the controller and the gesture type is the downward swipe, the second screen may be the set timer screen, (d) when the treatment mode has been programmed to the controller and the gesture type is the upward swipe, the second screen may be the treatment mode info screen displaying information about the programmed treatment mode, (e) when the treatment mode has not been programmed to the controller and the gesture type is the upward swipe, the second screen may be the treatment mode info screen displaying information about a plurality of treatment modes, (f) the first screen includes a first plurality of treatment modes and the second screen includes a second plurality of treatment modes, wherein the treatment parameter may be a treatment mode of one of the pluralities of treatment modes, and wherein the gesture type may be a leftward swipe or a rightward swipe, (g) timing the period of time the second screen is displayed on the display with a timer and displaying the first screen on the display after a predetermined period of time, and/or (h) detecting the user input to the at least one user input component associated with the treatment mode of one of the pluralities of treatment modes and programming the treatment mode to the controller.

Another aspect of the present technology is directed to a domestic appliance that treats contents. The appliance includes a display configured to display a first screen and a second screen, said first screen and said second screen being different, at least one user input component programmed to detect user input, and a controller programmed to correlate the user input to a gesture type, to determine the gesture type from among a plurality of gesture types, and to instruct the display to display the second screen according to at least the gesture type.

In examples, (a) the controller is programmed to determine whether a treatment parameter has been programmed to the controller, wherein the gesture type comprises an upward swipe or a downward swipe, wherein the second screen comprises one of a treatment mode info screen, a timer info screen, and a set timer screen, and wherein the treatment parameter comprises at least one of a treatment mode, a timer selection, and a treatment time, (b) when the timer selection and the treatment time have been programmed to the controller and the gesture type is the downward swipe, the second screen may be a timer info screen that displays the timer selection and the treatment time, (c) when the timer selection and the treatment time have not been programmed to the controller and the gesture type is the downward swipe, the second screen may be the set timer screen, (d) when the treatment mode has been programmed to the controller and the gesture type is the upward swipe, the second screen may be the treatment mode info screen displaying information about the programmed treatment mode, (e) when the treatment mode has not been programmed to the controller and the gesture type is the upward swipe, the second screen may be the treatment mode info screen displaying information about a plurality of treatment modes, (f) a timer programmed to time the period of time the second screen may be displayed on the display and the display may be configured to display the first screen after a predetermined period of time, and/or (g) the first screen may include a first plurality of treatment modes and the second screen may include a second plurality of treatment modes, wherein the treatment parameter may be a treatment mode of one of the pluralities of treatment modes, and wherein the gesture type may be a leftward swipe or a rightward swipe.

Another aspect of the present technology is directed to a method for controlling a domestic appliance that treats contents, said domestic appliance having a display, a controller, and at least one user input component. The method includes displaying one of a first screen, a second screen, and a third screen on the display, detecting user input to the at least one user input component, correlating the user input to a gesture type with the controller, determining the gesture type from among a plurality of gesture types with the controller, and displaying one of the first screen, the second screen, and the third screen according the gesture type, wherein each of the first screen, the second screen, and the third screen includes a different plurality of treatment modes.

In examples, (a) the gesture type may be one of a leftward swipe and a rightward swipe, (b) when the first screen is displayed and the gesture type is the rightward swipe the first screen may continue to be displayed, (c) when the first screen is displayed and the gesture type is the leftward swipe, the second screen may be displayed, (d) when the second screen is displayed and the gesture type is the rightward swipe, the first screen may be displayed, (e) when the second screen is displayed and the gesture type is the leftward swipe, the third screen may be displayed, (f) when the third screen is displayed and the gesture type is the rightward swipe, the second screen may be displayed, and/or (g) when the third screen is displayed and the gesture type is the leftward swipe, the third screen may continue to be displayed.

Other aspects, features, and advantages of this technology will become apparent from the following detailed description when taken in conjunction with the accompanying drawings, which are a part of this disclosure and which illustrate, by way of example, principles of this technology.

### BRIEF DESCRIPTION OF THE DRAWINGS

The accompanying drawings facilitate an understanding of the various examples of the present technology. In such drawings:

FIG. 1 is a perspective view of a domestic appliance having a user interface, according to an example of the present technology.

FIG. 2 is a schematic of the user interface, according to an example of the present technology.

FIG. 3 is a block diagram of a processing system, according to an example of the present technology.

FIG. 4 is a flowchart of a method of controlling a domestic appliance, according to an example of the present technology.

FIG. 5 is a flowchart of a method of controlling a domestic appliance, according to another example of the present technology.

FIG. 6 is a flowchart of a method of controlling a domestic appliance, according to another example of the present technology.

FIG. 7 is a flowchart of a method of controlling a domestic appliance, according to another example of the present technology.

FIG. 8 is a view of user input to a user input component of a domestic appliance, according to an example of the present technology.

FIG. 9 is a view of user input to a user input component of a domestic appliance, according to another example of the present technology.

FIG. 10 is a view of user input to a user input component of a domestic appliance, according to another example of the present technology.

FIG. 11 is a view of user input to a user input component of a domestic appliance, according to another example of the present technology.

### DETAILED DESCRIPTION OF ILLUSTRATED EXAMPLES

The following description is provided in relation to several examples which may share common characteristics and features. It is to be understood that one or more features of any one example may be combinable with one or more features of the other examples. In addition, any single feature or combination of features in any of the examples may constitute additional examples.

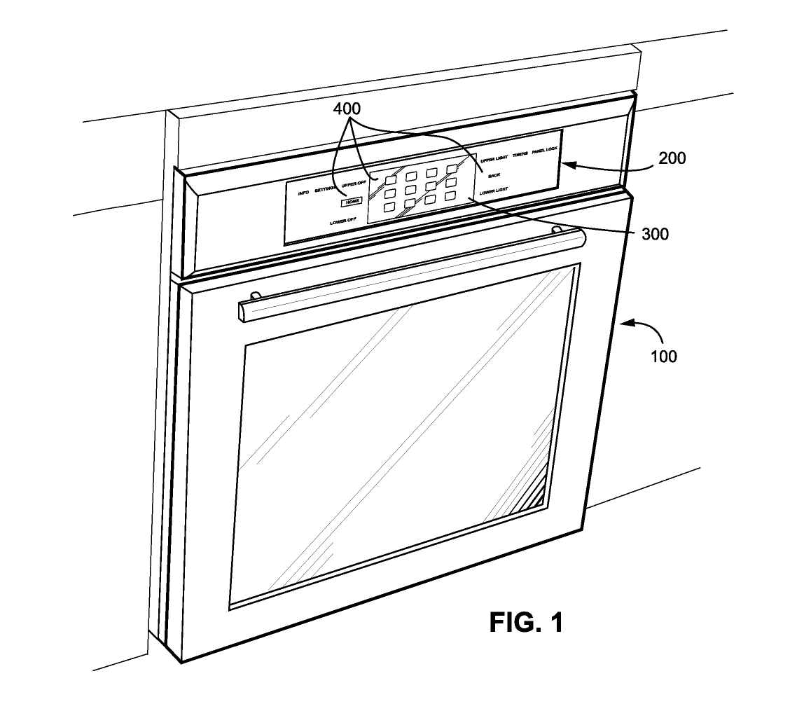

FIG. 1 shows a perspective view of a domestic appliance 100 installed as it commonly would be in a home. The particular domestic appliance 100 shown is an oven installed in a wall of a kitchen. The domestic appliance 100 of FIG. 1 shows a user interface 200 having a display 300. In this example, the display 300 may be a thin film transistor display that may include at least one user input component 400 that may be a capacitive touch input element.

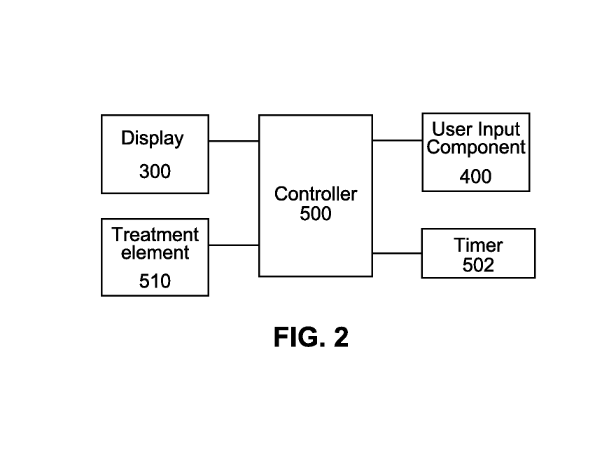

FIG. 2 shows a schematic of the components of the user interface of a domestic appliance in accordance with the present technology. The components may include a controller 500 for coordinating the operation of the user interface. A display 300 may be operationally controlled by the controller 500. A timer 502 may be included to time how long a particular screen is displayed on the display 300 or to time a period of inactivity. The period of inactivity being a time during which no user input is detected by the system. The user input component 400 may be any type of component that receives an input from a user and communicates or programs the same to the controller 500. Specifically, it is envisioned that commonly known touchscreen input devices, such as a capacitive touch input element, will comprise the user input component.

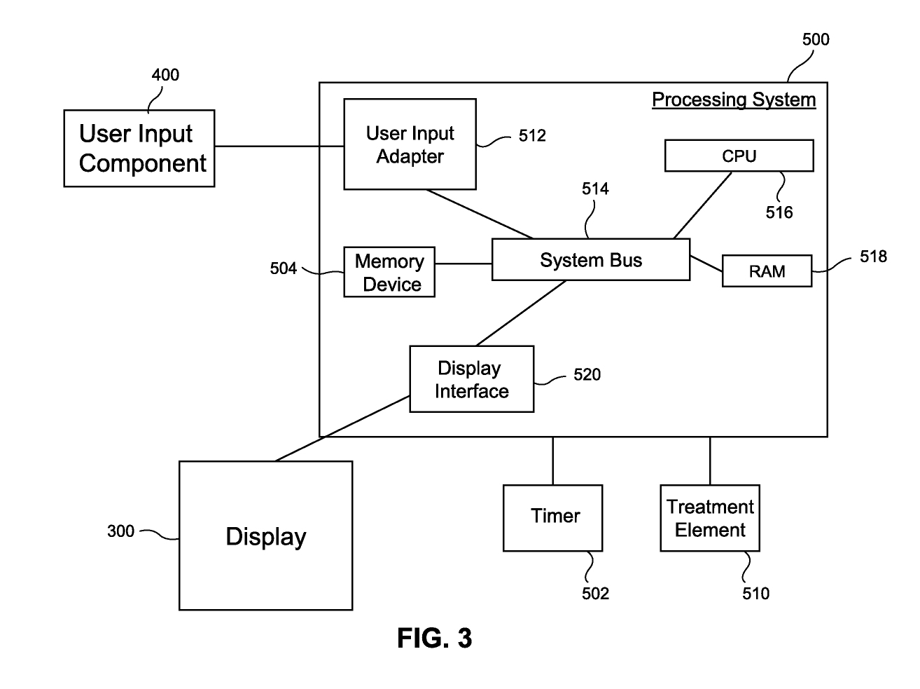

FIG. 3 is a block diagram of an exemplary computing system according to certain examples. A processing system or controller 500 may include a central processing unit or CPU 516, a system bus 514 that communicates with RAM 518 and storage or a memory device 504. The storage 504 can be magnetic, flash based, solid state, or other storage technology. The system bus 514 may also communicate with a user input adapter 512 that allows users to input commands to the processing system via a user input component 400 (e.g., a touch input element or the like) and/or buttons 400. The results of the processing may be displayed to a user on a display 300 via a display interface 520 (e.g., a video card or the like). The memory device 504 may be included to store the functional parameters (e.g., treatment time, treatment mode, treatment temperature, etc.) input to the controller 500 through the user input component 400. At least one treatment element 510 may also be included for the treatment of the contents of the appliance.

The treatment element(s) 510 may be included to facilitate the treatment of contents by the domestic appliance 100. For example, the domestic appliance 100 may also include a chamber that holds the contents and a door to enclose the contents in the domestic appliance 100 and such domestic appliance may be an oven, a dishwasher, a washing machine, a drier, a microwave oven, a coffee maker, a refrigerator, and/or a freezer, etc. Thus, the contents may be food, consumable liquids, crockery, dishes, stoneware, flatware, bakeware, and/or clothing, etc. It is also contemplated that the domestic appliance may not necessarily include a chamber for treating the contents or items and in such a case the domestic appliance may be a vacuum cleaner, a blender, and an iron, etc. Treatment by the domestic appliance is contemplated to comprise cooking, baking, heating, steaming, sanitizing, dis-infecting, cooling, freezing, cleaning, washing, vacuuming, and/or blending, etc. The treatment element 510, in the example where the appliance 100 is an oven and the contents are food, is at least one heating element that may include an electric resistance heating element or a gas burner. A fan may also comprise the treatment element 510 in the case of a convection oven that performs convection heating of the food. Other treatment elements, as commonly known in the art, may also comprise the treatment element.

The processing system 500 may also communicate with the additional components of the domestic appliance, e.g., timer 502 and treatment element 510. It should also be noted that the timer 502 may be comprised within the processing system 500, rather than as a separate component.

Certain examples herein are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both.

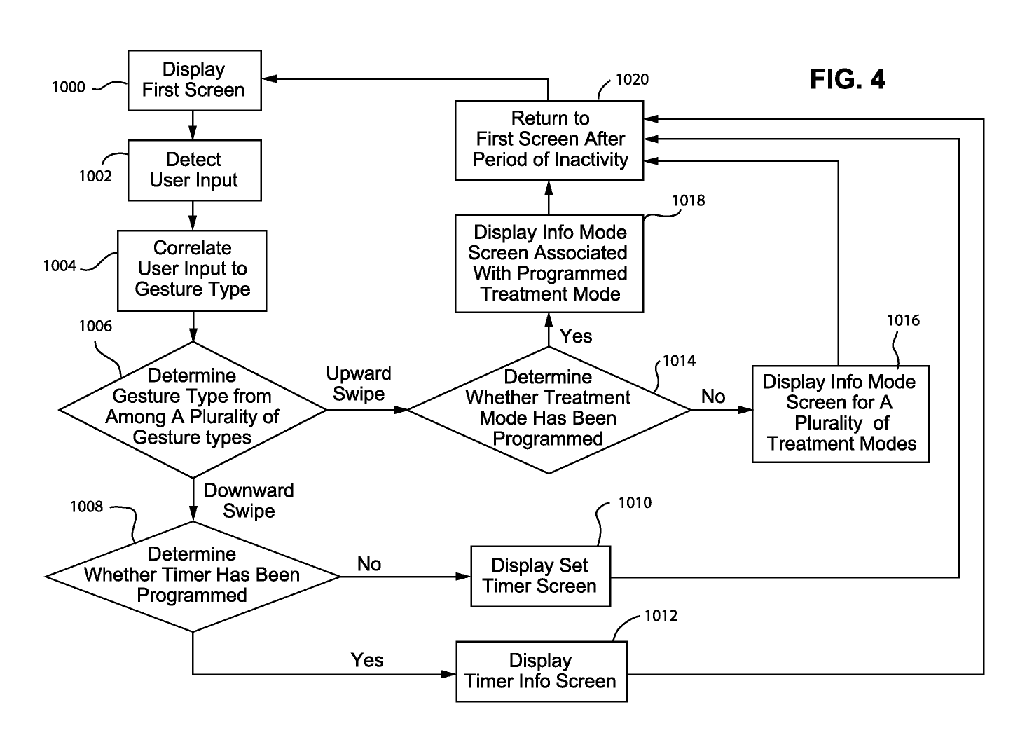

FIG. 4 shows a flowchart of an exemplary method for controlling a domestic appliance. A first screen may be displayed by the display 300 and may be any of a plurality of screens that are displayed to the user. This function is exemplified at step 1000. A user may then provide user input to the at least one user input component 400 and the user input component will detect the user input. This function is exemplified at step 1002. The user input detected by the user input component 400 may then be communicated or programmed to the controller 500 where the user input is correlated to one of a plurality of gesture types. This function is exemplified by step 1006. Subsequently, once the user input has been correlated to a gesture type, the controller 500 may then determine the gesture type from among a plurality of gesture types (which may be stored in the memory device 504 or accessed in other ways, such as the internet), as exemplified in step 1006. In this particular example, the controller 500 may determine that the user has either provided a downward swipe or an upward swipe to the user input component 400. This functionality may be accomplished by comparing the user input detected by the user input component to a plurality of gesture types stored in at least one lookup table.

If the controller 500 determines that a downward swipe has been inputted by the user, the controller 500 may then determine whether a timer 502 of the domestic appliance 100 has been programmed. This function is exemplified by step 1008. If the controller 500 determines that the timer 502 of the domestic appliance 100 has been programmed, then the display 300 may display a timer info screen which shows the timer parameters as programmed and in which the parameters can be changed. This function is exemplified by step 1012. If no further inputs are detected by the user input component 400 (i.e., a period of inactivity) after a period of time, the display 300 may display the first screen. This function is exemplified by step 1020.

If the controller 500 determines that the timer 502 of the domestic appliance has not been programmed, then the display 300 may display a set timer screen. This function is exemplified by step 1010. If no further inputs are detected by the user input component 400 (i.e., a period of inactivity) after a period of time, the display 300 may display the first screen. This function is exemplified by step 1020.

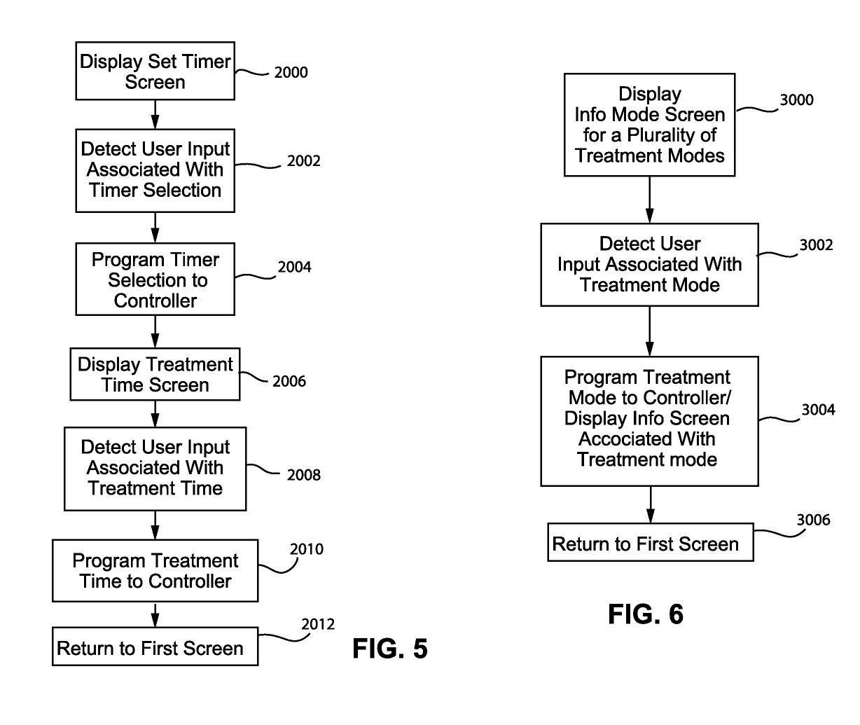

At step 1010, the user may also be presented with the option to program the timer 502 by the set timer screen, rather than letting the screen lapse and return the display 300 to the first screen. FIG. 5 shows an exemplary method by which the user may program the timer 502. The set timer screen may first be displayed by the display 300. This function is exemplified by step 2000, which corresponds to step 1010 of FIG. 4. The user may then provide user input associated with a timer selection to the user input component 400 which detects the user input, as exemplified by step 2002. The user input component 400 may then program the timer selection to the controller 500. This function is exemplified by step 2004. A treatment time screen may then be displayed by the display 300, as exemplified by step 2006. The user may then provide user input associated with a treatment time to the user input component 400 which may detect the user input, as exemplified by step 2008. The user input component 400 may then program the treatment time to the controller 500. This function is exemplified by step 2010. Once these parameters have been programmed, the display 300 may return to the first screen.

At step 1006, the controller 500 may also determine that an upward swipe has been inputted from among a plurality of gesture types. If so, the controller 500 may then determine whether a treatment mode has been programmed. This function is exemplified in step 1014. If the controller 500 determines that a treatment mode has been programmed, then the display 300 may display an info mode screen associated with the programmed treatment mode. This function is exemplified in step 1018. If no further inputs are detected by the user input component 400 (i.e., a period of inactivity) after a period of time, the display 300 may display the first screen. This function is exemplified by step 1020.

If the controller 500 determines that the treatment mode has not been programmed, then the display 300 may display an info mode for a plurality of treatment modes. This function is exemplified by step 1016. If no further inputs are detected by the user input component 400 (i.e., a period of inactivity) after a period of time, the display 300 may display the first screen. This function is exemplified by step 1020.

At step 1016, the user may also be presented with the option to program the treatment mode by the treatment mode info screen and/or may have the display 300 display further information about any of the plurality of treatment modes, rather than letting the screen lapse and return the display 300 to the first screen. FIG. 6 shows an exemplary method by which the user may program the treatment mode. The info mode screen for a plurality of treatment modes may be displayed, as exemplified by step 3000. The user may then provide user input associated with the one of the plurality of treatment modes displayed to the user input component 400, as exemplified by step 3002. The user input component 400 may communicate or program the treatment mode to the controller 500 or the display 300 may display an info mode screen associated with the treatment mode, in accordance with the user input detected. This function is exemplified by step 3004. After programming the treatment mode or displaying an info mode screen associated therewith, the display will return to the first screen, as exemplified by step 3006.

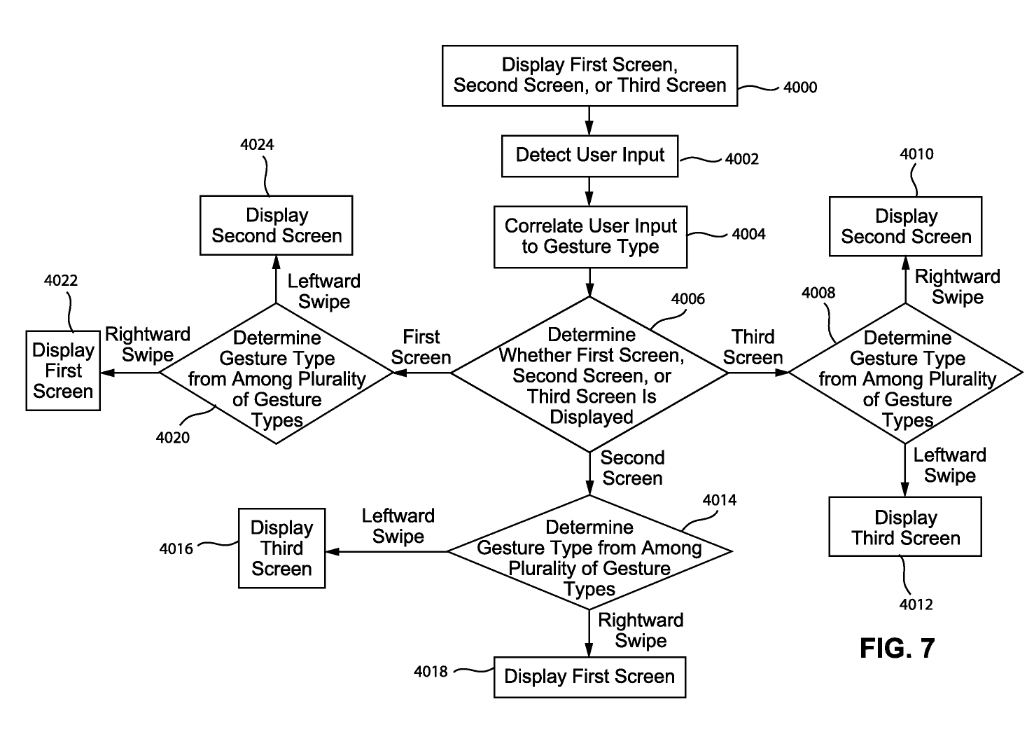

FIG. 7 shows a flowchart for another exemplary method of controlling the domestic appliance 100 or navigating through a plurality of screens. One of a plurality of screens may be displayed by the display 300. These screens may be one of a first screen, a second screen, or a third screen. This function is exemplified by step 4000. The user input component 400 may then detect user input from the user and program or communicate the same to the controller, as exemplified by step 4002. The controller 500 may then correlate the user input to a gesture type, as exemplified by step 4004. The controller 500 then determines which one of the first, second, or third screen is displayed, as exemplified by step 4006. The controller 500 may then determine the gesture type from among a plurality of gesture types, as exemplified by steps 4008, 4014, and 4020. This functionality may be accomplished by comparing the user input detected by the user input component to a plurality of gesture types stored in at least one lookup table.

Depending on which screen is initially displayed and the gesture type detected, the display 300 may display a subsequent screen accordingly. If the first screen is displayed and the gesture type is the rightward swipe, then the first screen will continue to be displayed, as exemplified by step 4022. If the first screen is displayed and the gesture type is the leftward swipe, then second screen will be subsequently displayed, as exemplified by step 4024. If the second screen is displayed and the gesture type is the leftward swipe, then the third screen may be subsequently displayed, as exemplified by step 4016. If the second screen is displayed and the gesture type is the rightward swipe, then the first screen may be subsequently displayed, as exemplified by step 4018. If the third screen is displayed and the gesture type is the rightward swipe, then second screen may subsequently be displayed, as exemplified by step 4010. If the third screen is displayed and the gesture type is the leftward swipe, then the third screen may continue to be displayed, as exemplified by step 4012.

The gestures described thus far are not intended to be the only types of gestures capable of controlling the domestic appliance. It is also contemplated that a variety of other gestures could be detected to control the appliance, e.g., gestures taking the form of one or more alphanumeric characters or symbols, etc. Furthermore, gestures may be complex and include a number of swipes in a number of directions to affect a single control step. Providing more complex gestures such as characters, symbols, or multiple swipes may allow the user to control a variety of functions while allowing the domestic appliance to effectively differentiate the gestures to correctly perform the function desired by the user and/or technician.

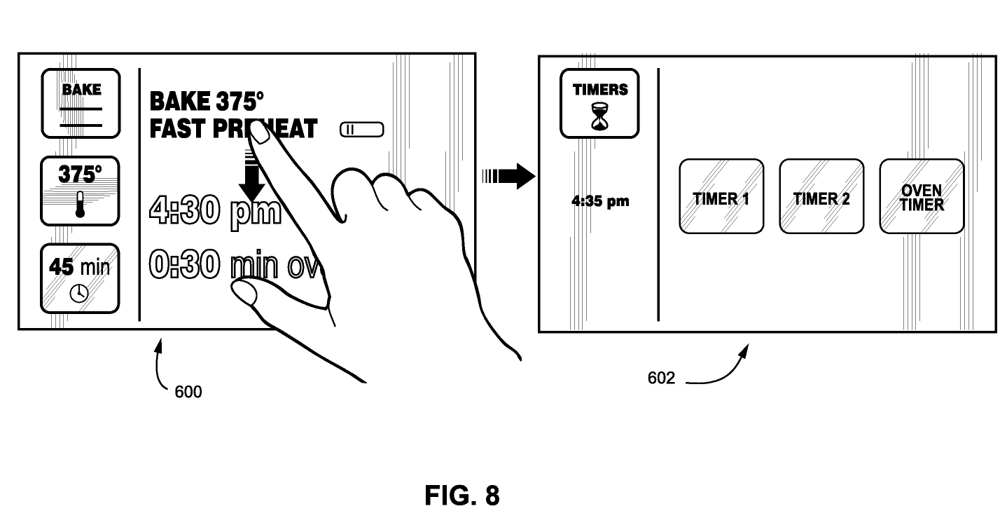

FIG. 8 shows a view of user input causing the screen displayed to change according to steps 1000 through 1010 of FIG. 4. First screen 600 may be displayed and the user may provide user input in the form of a downward swipe. The user input component 400 may then detect the user input and the controller 500 may correlate the user input to a gesture type and determine the gesture type from among the plurality of gesture types. In this example, the controller 500 has determined that the timer 502 has not been programmed. Subsequently, the set timer screen 602 is displayed.

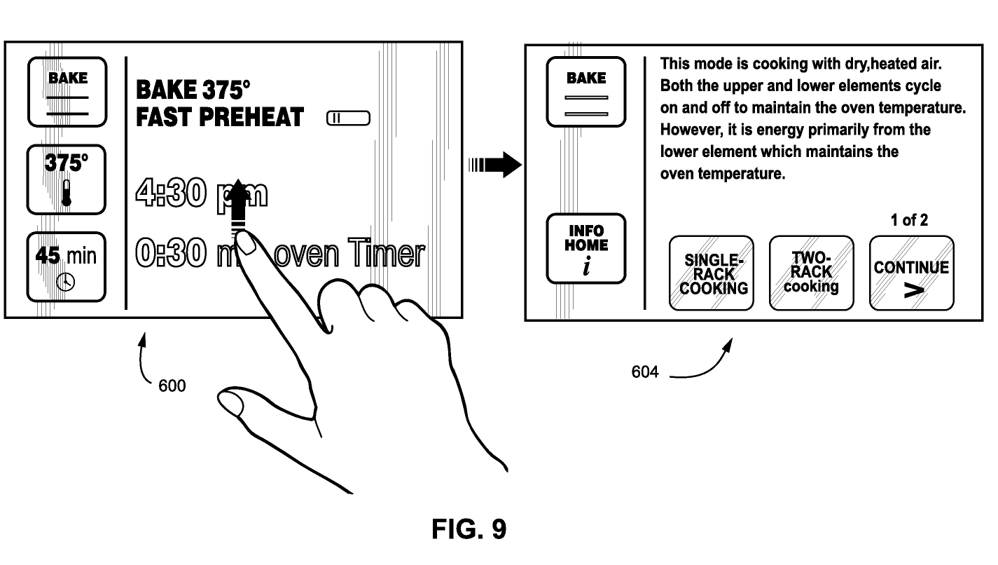

FIG. 9 shows a view of user input causing the screen displayed to change according to steps 1000, 1002, 1004, 1006, 1014, and 1018 of FIG. 4. First screen 600 may be displayed and the user may provide user input in the form of an upward swipe. The user input component 400 may then detect the user input and the controller 500 may correlate the user input to a gesture type and determines the gesture type from among the plurality of gesture types. In this example, the controller 500 has determined that the treatment mode has not been programmed. Subsequently, the info mode screen associated with the programmed treatment mode may be displayed.

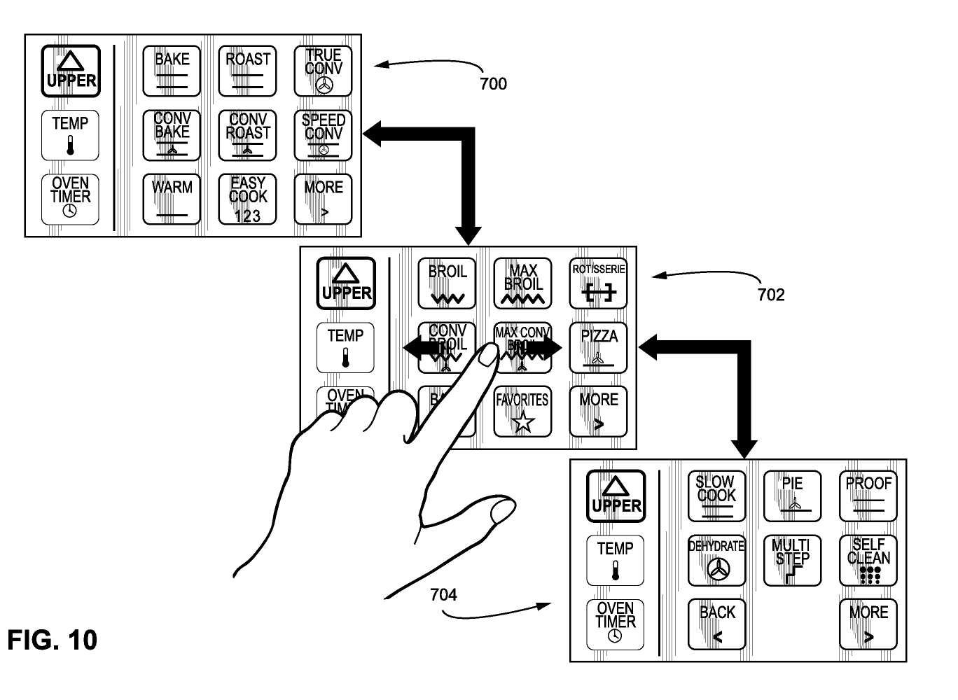

FIG. 10 is a view of user inputs to the user input component 400. These user inputs affect navigation through a plurality of screens. FIG. 10 is also a further depiction of the method shown in FIG. 7. This view shows user inputs that correspond to leftward and rightward swipes which may be detected by the user input component 400 and correlated to a gesture type by the controller 500. The controller 500 may then determine the gesture type from among the plurality of gesture types. Depending on which of the first screen 700, second screen 702, and third screen 704 is displayed and the gesture type detected, one of the aforementioned screens may then be displayed according to the method shown in FIG. 7.

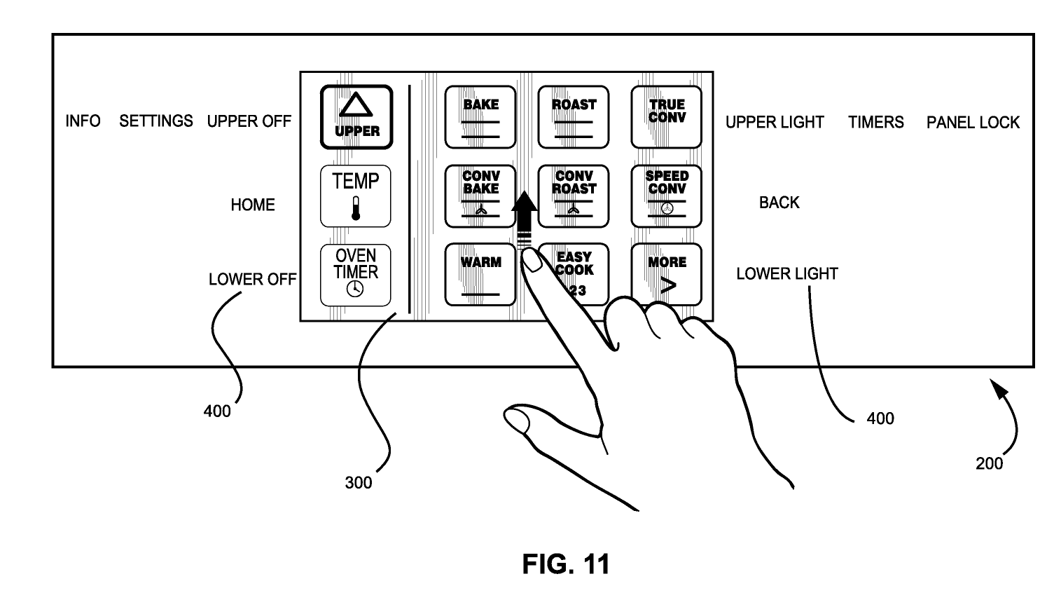

FIG. 11 is a view of user input to the user input component 400. The user input component 400 may be coextensive with the display 300 such that the user may interact with portions of the image displayed on the screen. In this view, exemplary user inputs are shown where the hand of a user is shown providing an input to the user input component 400. Specifically, the upward swipe of the plurality of gesture types is indicated by the arrow.

While the present technology has been described in connection with what are presently considered to be the most practical and preferred examples, it is to be understood that the technology is not to be limited to the disclosed examples, but on the contrary, is intended to cover various modifications and equivalent arrangements included within the spirit and scope of the technology.

What is claimed is:

1. A method for controlling a domestic appliance to treat contents, said domestic appliance having a display, a controller, and at least one user input component, the method comprising:
displaying a first screen on the display;
detecting user input to the at least one user input component;
correlating the user input to a gesture type with the controller;
determining the gesture type from among a plurality of gesture types with the controller; and
displaying a second screen on the display according to at least the gesture type,
wherein said second screen is different from said first screen.

2. The method of claim 1, further comprising:
determining whether at least one treatment parameter has been programmed to the controller, wherein the gesture type comprises an upward swipe or a downward swipe,
wherein the second screen comprises one of a treatment mode info screen, a timer info screen, and a set timer screen, and wherein the at least one treatment parameter comprises at least one of a treatment mode, a timer selection, and a treatment time.

3. The method of claim 2, wherein when the timer selection and the treatment time have been programmed to the controller and the gesture type is the downward swipe, the second screen is the timer info screen that displays the timer selection and the treatment time.

4. The method of claim 2, wherein when the timer selection and the treatment time have not been programmed to the controller and the gesture type is the downward swipe, the second screen is the set timer screen.

5. The method of claim 2, wherein when the treatment mode has been programmed to the controller and the gesture type is the upward swipe, the second screen is the treatment mode info screen displaying information about the programmed treatment mode.

6. The method of claim 2, wherein when the treatment mode has not been programmed to the controller and the gesture type is the upward swipe, the second screen is the treatment mode info screen displaying information about a plurality of treatment modes.

7. The method of claim 1, further comprising:
displaying a set timer screen on the display:
detecting user input to the at least one user input component associated with a timer selection;
programming the timer selection to the controller;
displaying a treatment time screen on the display;
detecting user input to the at least one user input component associated with a treatment time; and
programming the treatment time to the controller.

8. The method of claim 1, further comprising:
timing the period of time the second screen is displayed on the display with a timer; and
displaying the first screen on the display after a predetermined period of time.

9. The method of claim 1, wherein the first screen includes a first plurality of treatment modes and the second screen includes a second plurality of treatment modes, wherein the treatment parameter is a treatment mode of one of the pluralities of treatment modes, and wherein the gesture type is a leftward swipe or a rightward swipe.

10. The method of claim 9, further comprising:
detecting the user input to the at least one user input component associated with the treatment mode of one of the pluralities of treatment modes; and
programming the treatment mode to the controller.

11. The method of claim 1, wherein the at least one user input component comprises at least one touch input element.

12. The method of claim 1, further comprising:
treating the contents of the domestic appliance with at least one treatment element.

13. The method of claim 12, wherein the at least one treatment element is at least one heating element.

14. A domestic appliance to treat contents, the appliance comprising:
a display configured to display a first screen and a second screen, said first screen and said second screen being different;
at least one user input component programmed to detect user input; and
a controller programmed to correlate the user input to a gesture type, to determine the gesture type from among a plurality of gesture types, and to instruct the display to display the second screen according to at least the gesture type.

15. The domestic appliance of claim 14, further comprising:
the controller programmed to determine whether a treatment parameter has been programmed to the controller, wherein the gesture type comprises an upward swipe or a downward swipe, wherein the second screen comprises one of a treatment mode info screen, a timer info screen, and a set timer screen, and wherein the treatment parameter comprises at least one of a treatment mode, a timer selection, and a treatment time.

16. The domestic appliance of claim 15, wherein when the timer selection and the treatment time have been programmed to the controller and the gesture type is the downward swipe, the second screen is a timer info screen that displays the timer selection and the treatment time.

17. The domestic appliance of claim 15, wherein when the timer selection and the treatment time have not been programmed to the controller and the gesture type is the downward swipe, the second screen is the set timer screen.

18. The domestic appliance of claim 15, wherein when the treatment mode has been programmed to the controller and the gesture type is the upward swipe, the second screen is the treatment mode info screen displaying information about the programmed treatment mode.

19. The domestic appliance of claim 15, wherein when the treatment mode has not been programmed to the controller and the gesture type is the upward swipe, the second screen is the treatment mode info screen displaying information about a plurality of treatment modes.

20. The domestic appliance of claim 14, further comprising:
the display configured to display a set timer screen and a treatment time screen;
the at least one user input component configured to detect user input associated with a timer selection and user input associated with a treatment time and to program the timer selection and treatment time to the controller.

21. The domestic appliance of claim 14, further comprising:
a timer programmed to time the period of time the second screen is displayed on the display; and
the display configured to display the first screen after a predetermined period of time.

22. The domestic appliance of claim 14, wherein the first screen includes a first plurality of treatment modes and the second screen includes a second plurality of treatment modes, wherein the treatment parameter is a treatment mode of one of the pluralities of treatment modes, and wherein the gesture type is a leftward swipe or a rightward swipe.

23. The domestic appliance of claim 22, further comprising:
the display configured display a treatment mode screen;
the at least one user input component configured detect user input associated with a treatment mode and to program the treatment mode to the controller.

24. The domestic appliance of claim 14, wherein the display comprises a thin film transistor display.

25. The domestic appliance of claim 14, wherein the at least one user input component comprises at least one touch input element.

26. The domestic appliance of claim 25, wherein the at least one touch input element comprises a capacitive touch input element.

27. The domestic appliance of claim 14, further comprising:
at least one treatment element configured to treat the contents of the domestic appliance.

28. The domestic appliance of claim 27, wherein the at least one treatment element is at least one heating element.

29. The domestic appliance of claim 14, further comprising:
an oven;
a treatment chamber; and
a door to enclose said treatment chamber.

30. A method for controlling a domestic appliance that treats contents, said domestic appliance having a display, a controller, and at least one user input component, the method comprising:
displaying one of a first screen, a second screen, and a third screen on the display;
detecting user input to the at least one user input component;
correlating the user input to a gesture type with the controller;
determining the gesture type from among a plurality of gesture types with the controller; and
displaying one of the first screen, the second screen, and the third screen according the gesture type, wherein each of the first screen, the second screen, and the third screen includes a different plurality of treatment modes.

31. The method of claim 30, wherein the gesture type is one of a leftward swipe and a rightward swipe.

32. The method of claim 31, wherein when the first screen is displayed and the gesture type is the rightward swipe the first screen continues to be displayed.

33. The method of claim 31, wherein when the first screen is displayed and the gesture type is the leftward swipe the second screen is displayed.

34. The method of claim 31, wherein when the second screen is displayed and the gesture type is the rightward swipe the first screen is displayed.

35. The method of claim 31, wherein when the second screen is displayed and the gesture type is the leftward swipe the third screen is displayed.

36. The method of claim 31, wherein when the third screen is displayed and the gesture type is the rightward swipe the second screen is displayed.

37. The method of claim 31, wherein when the third screen is displayed and the gesture type is the leftward swipe the third screen continues to be displayed.
